(19) United States
(12) Patent Application Publication
(10) Pub. No.: US 2011/0110713 A1
(43) Pub. Date: May 12, 2011

(54) FASTENER

(75) Inventors: CHIA-SHIN CHOU, Tu-Cheng (TW); ZHEN-XING YE, Shenzhen City (CN); XIAN-XIU TANG, Shenzhen City (CN)

(73) Assignees: HONG FU JIN PRECISION INDUSTRY (ShenZhen) CO.,. LTD., Shenzhen City (CN); HON HAI PRECISION INDUSTRY CO., LTD., Tu-Cheng (TW)

(21) Appl. No.: 12/760,561

(22) Filed: Apr. 15, 2010

(30) Foreign Application Priority Data
Nov. 9, 2009 (CN) 200910309451.2

(51) Int. Cl. F16B 2/22

(52) U.S. Cl. 403/291

(57) ABSTRACT

A fastener mounting a fan onto a particular device includes a retaining member of a soft material and an attaching member of a rigid material. The material forming the retaining member is less rigid than that of the material forming the attaching member. The retaining member includes a hollow sleeve, a retaining portion formed on the sleeve and retaining the retaining member to the fan. The attaching member includes a body received into the sleeve of the retaining member and an attaching portion formed on the body and attaching the attaching member to the particular device.

### BACKGROUND

1. Technical Field

The disclosure relates to device installation and, more particularly, to a fastener for installing a fan.

2. Description of Related Art

Often, fastening a fan in a computer includes fastening the fan directly via locking metal screws, a low cost solution, but one in which vibration is easily generated, or use of rubber fasteners, providing resilience and vibration resistance, but with difficulty of assembly, and marked aging, even fracturing, with use.

What is needed, therefore, is a fastener which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of a fastener in accordance with an embodiment of the disclosure.

FIG. 2 is an exploded view of the fastener of FIG. 1.

FIG. 3 is a cross-section of the fastener of FIG. 1.

FIG. 4 is a view of the fastener mounting a fan on a computer chassis.

### DETAILED DESCRIPTION

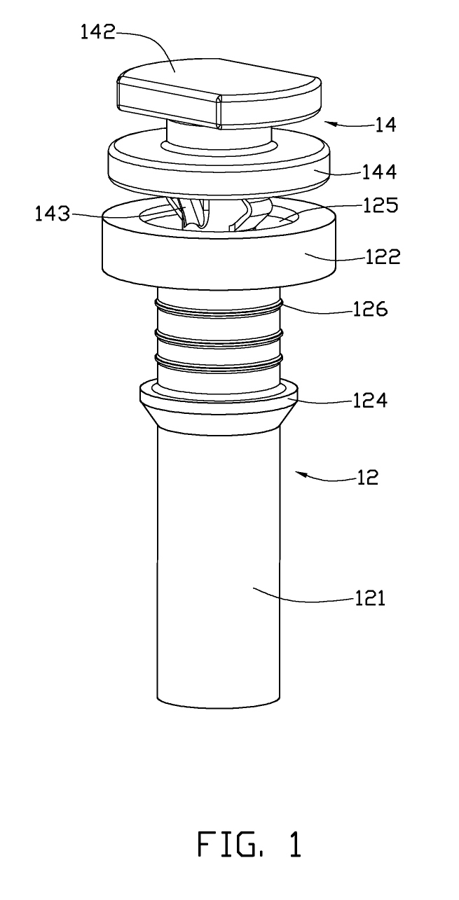

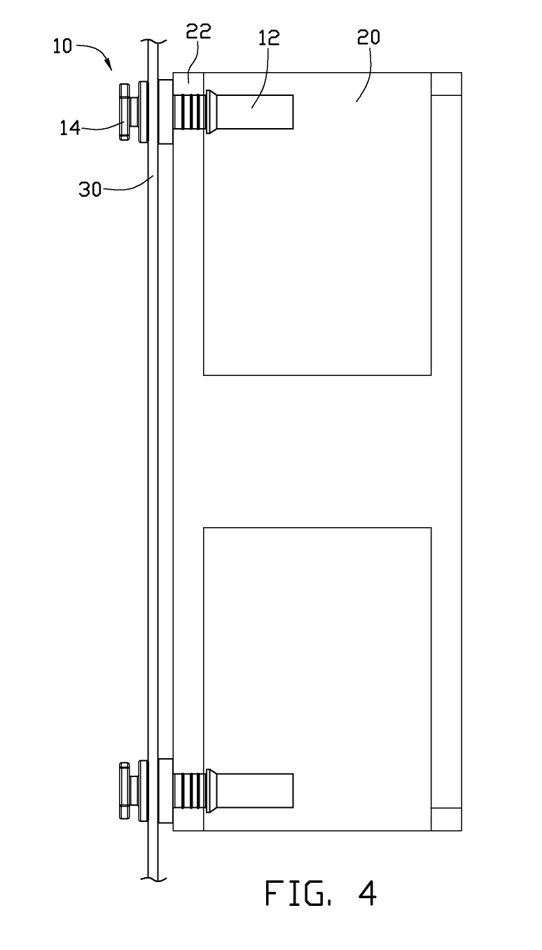

FIGS. 1 and 4 show a fastener 10 fixing a fan 20 to a computer chassis 30. The fan 20 includes a fan frame having a flange 22 formed on a top and bottom thereof.

A plurality of through holes (not labeled) is defined in four corners of the flange 22. A plurality of fixing holes (not shown) is defined in the computer chassis 30, corresponding to the through holes of the fan 20.

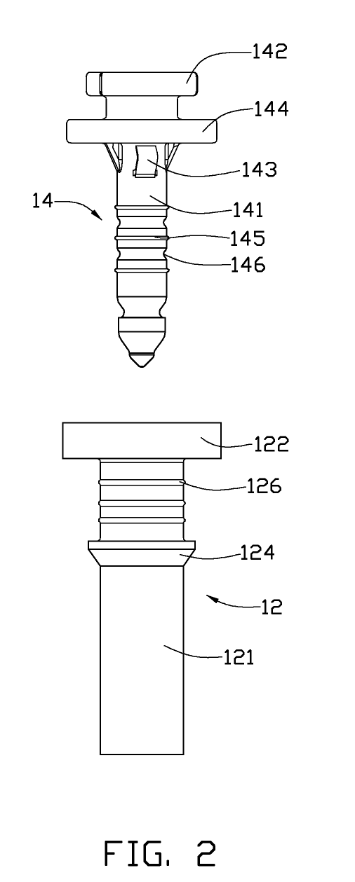

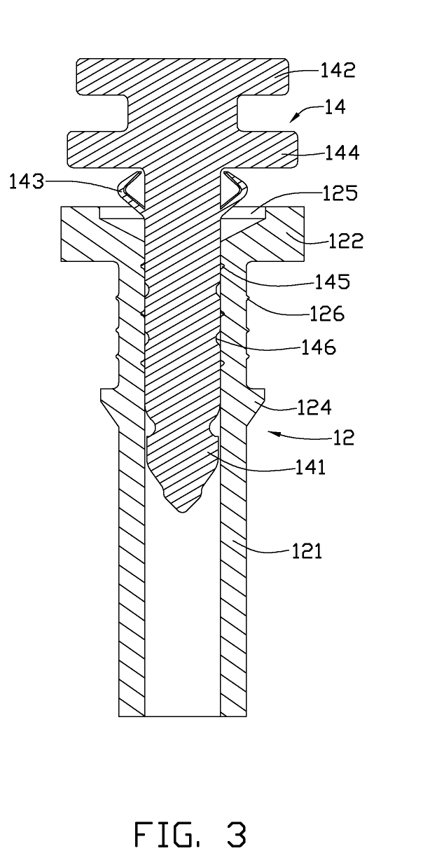

Also referring to FIGS. 2-3, the fastener 10 includes a retaining member 12 and an attaching member 14 to connect with the retaining member 12. The retaining member 12 extends through the through hole of the fan 20 and is attached on the fan 20. The attaching member 14 extends through the fixing hole of the computer chassis 30 and is attached on the computer chassis 30.

The retaining member 12 is made of a soft material such as rubber, and constitutes a cylindrical hollow sleeve 121, a circular head 122 formed at a top of the sleeve 121, and an annular flexible ring 124 formed at an outer face of the sleeve 121 beneath the head 122. The ring 124 spaces a particular distance from the head 122. The portion of the sleeve 121 between the head 122 and the ring 124 forms a retaining portion for the fan 20. The sleeve 121 extends through the through hole of the fan 20 and the flange 22 of the fan 20 is sandwiched between the head 122 and the ring 124, thereby attaching the retaining member 12 to the fan 20. The sleeve 121 has an outer diameter exceeding an inner diameter of the through hole of the fan 20. The ring 124 has an outer diameter gradually increasing from bottom to top direction and can contract to extend through the through hole of the fan 20. The outer diameter of the ring 124 is smaller than an outer diameter of the head 122. Three annular protrusions 126 protrude radially outwardly from the outer face of the sleeve 121 between the head 122 and the ring 124. The protrusions 126 are evenly spaced and elastically contact an inner wall of the through hole of the fan 20 to reduce a contact area between the retaining member 12 and the fan 20, such that vibration conducted to the retaining member 12 is reduced during operation of the fan 20. A recess 125 is defined in a top of the head 122 and is in communication with an interior of the sleeve 121. The recess 125 has a tapered inner wall with an inner diameter gradually increasing from bottom to top.

The attaching member 14 is made of a rigid material such as plastic. The material forming the retaining member 12 is less rigid than the material forming the attaching member 14. The attaching member 14 includes a columnar body 141 to be received in the sleeve 121 of the retaining member 12, a circular shoulder 144 formed at a top of the body 141, and four resilient tabs 143 formed at an outer surface of the body 141 beneath the shoulder 144. The portion of the body 141 between the shoulder 144 and the resilient tabs 143 forms an attaching portion for attaching to the computer chassis 30. The body 141 extends through the fixing hole of the computer chassis 30 and the computer chassis 30 is sandwiched between the shoulder 144 and the resilient tabs 143. The resilient tabs 143 each angle toward the shoulder 144. Each resilient portion 143 is substantially C-shaped and extends firstly outwardly and upwardly and then inwardly and upwardly, whereby the resilient portion 143 has a free end bent toward the shoulder 144 of the body 141. The free end of each resilient tab 143 is located adjacent to but not contacting the shoulder 144 of the body 141. The resilient tab 143 can contract to extend through the fixing hole of the computer chassis 30 to sandwich the computer chassis 30 between the shoulder 144 and the resilient tabs 143 of the attaching member 14. A head 142 is formed above the shoulder 144 for facilitating insertion of the attaching member 14 into the retaining member 12 or detachment thereof from the retaining member 12. Three annular protrusions 145 protrude outwardly from an outer surface of the body 141 beneath the resilient tabs 143. Two annular grooves 146 are defined around the body 141. The protrusions 145 and the grooves 146 are arranged around the body 141 alternatingly. When the attaching member 14 is received in the retaining member 12, the retaining member 12 is forced to deform outwardly and elastically and an inner wall of the retaining member 12 contacts the protrusions 145 of the attaching member 14. Due to the presence of the grooves 146, a contact area between the body 141 and the inner wall of the retaining member 12 is reduced, and the vibration conducted to the attaching member 14 and the computer chassis 30 minimized.

During assembly, the sleeve 121 of the retaining member 12 extends through the through hole of the fan 20, so that the flange 22 of the fan 20 is sandwiched between the head 122 and the ring 124 of the sleeve 121. Thus, the retaining member 12 is retained with the fan 20 at the retaining portion between the head 122 and the ring 124 of the retaining member 12. The body 141 of the attaching member 14 extends through the fixing hole of the computer chassis 30, so that the computer chassis 30 is sandwiched between the shoulder 144 and the resilient tabs 143 of the body 141. Thus, the attaching member 14 is attached to the computer chassis 30 at the attaching portion between the shoulder 144 and the resilient tabs 143 of the attaching member 14. Then, the body 141 of the attaching member 14 is received into the retaining member 12 from the head 122 until the resilient tabs 143 are received in the recess 125 of the retaining member 12, and a top surface of the head 122 of the retaining member 12 abuts the computer chassis 30.

Since the retaining member 12 retained with the fan 20 is made of a soft material such as rubber, the vibration conducted to the computer chassis 30 is reduced during operation of the fan 20. Since the attaching member 14 is a rigid material such as plastic, the fan 20 can be fastened on the computer chassis 30 more firmly.

It is believed that the disclosure and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A fastener for mounting a fan onto a device, the fastener comprising:
a retaining member made of a soft material and comprising a hollow sleeve, the sleeve forming a retaining portion thereon, the retaining portion to retain the retaining member to the fan; and
an attaching member made of a rigid material and comprising a body to be received in the sleeve of the retaining member, the body forming an attaching portion thereon, the attaching portion to attach the attaching member to the device, the material forming the retaining member being less rigid than the material forming the attaching member.

2. The fastener as claimed in claim 1, wherein a head is formed at a top of the sleeve, a flexible ring is formed at an outer surface of the sleeve beneath the head, and the portion of the sleeve between the head and the flexible ring acts as the retaining portion of the retaining member.

3. The fastener as claimed in claim 2, wherein the flexible ring has an outer diameter gradually increasing from the flexible ring toward the head.

4. The fastener as claimed in claim 2, wherein a plurality of annular protrusions protrudes outwardly from an outer surface of the sleeve between the head and the flexible ring.

5. The fastener as claimed in claim 2, wherein a shoulder is formed at a top of the body, a plurality of resilient tabs are formed on an outer surface of the body beneath the shoulder, and the portion of the body between the shoulder and the resilient tabs forms as the attaching portion of the attaching member.

6. The fastener as claimed in claim 5, wherein each resilient tab is substantially C-shaped and angles toward the shoulder.

7. The fastener as claimed in claim 5, wherein the attaching member further comprises a head formed above the shoulder facilitating attachment to the attaching member.

8. The fastener as claimed in claim 5, wherein a plurality of annular protrusions protrudes outwardly from an outer surface of the body beneath the resilient tabs.

9. The fastener as claimed in claim 8, wherein a plurality of annular grooves is defined around the body beneath the resilient tabs, and the protrusions and the grooves are arranged along the body alternatingly.

10. The fastener as claimed in claim 5, wherein a recess is defined in a top of the head of the retaining member in communication with an interior of the sleeve of the retaining member, and the resilient tabs of the attaching member are received in the recess of the head.

11. The fastener as claimed in claim 1, wherein the material forming the retaining member is rubber, and the material forming the attaching member is plastic.

12. A fastener assembly, comprising:
a particular device defining a fixing hole therein;
a fan mounted to the particular device by a fastener, the fan defining a through hole therein, the fastener comprising:
a retaining member of a soft material and comprising a hollow sleeve, the sleeve forming a retaining portion thereon, the sleeve extending through the through hole of the fan and the retaining member being retained to the fan through the retaining portion; and
an attaching member of a rigid material and comprising a body, the body forming an attaching portion thereon, the body extending through the fixing hole of the particular device and the attaching member being attached to the particular device through the attaching portion, the body of the attaching member being received into the sleeve of the retaining member to connect the attaching member with the retaining member, the material forming the retaining member being less rigid than that of the material forming the attaching member.

13. The fastener assembly as claimed in claim 12, wherein a head is formed at a top of the sleeve, a flexible ring is formed at an outer surface of the sleeve beneath the head, and the portion of the sleeve between the head and the flexible ring acts as the retaining portion of the retaining member.

14. The fastener assembly as claimed in claim 13, wherein the flexible ring has an outer diameter gradually increasing along a direction from the flexible ring toward the head.

15. The fastener assembly as claimed in claim 13, wherein a plurality of annular protrusions protrudes outwardly from an outer surface of the sleeve between the head and the flexible ring.

16. The fastener assembly as claimed in claim 13, wherein a shoulder is formed at a top of the body, a plurality of resilient tabs is formed on an outer surface of the body beneath the shoulder, and the portion of the body between the shoulder and the resilient tabs acts as the attaching portion of the attaching member.

17. The fastener assembly as claimed in claim 16, wherein each resilient tab is substantially C-shaped and angles toward the shoulder.

18. The fastener assembly as claimed in claim 16, wherein the attaching member further comprises a head formed above the shoulder facilitating attachment to the attaching member.

19. The fastener assembly as claimed in claim 16, wherein a recess is defined in a top of the head of the retaining member in communication with an interior of the sleeve of the retaining member, and the resilient tabs of the attaching member are received in the recess of the head.

20. The fastener assembly as claimed in claim 12, wherein the material forming the retaining member is rubber, and the material forming the attaching member is plastic.
